(19) United States
(12) Patent Application Publication
(10) Pub. No.: US 2006/0079214 A1
(43) Pub. Date: Apr. 13, 2006

(54) Method and apparatus for showing wireless mobile device data content on an external viewer

(75) Inventors: Markus Mertama, Tampere (FI); Jorma Tornblom, Pirkkala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/246,048

(22) Filed: Oct. 6, 2005

Related U.S. Application Data
(60) Provisional application No. 60/617,939, filed on Oct. 12, 2004.

(51) Int. Cl. H04Q 7/38; G06F 17/00

(52) U.S. Cl. 455/414.1; 455/418; 715/500.1

(57) ABSTRACT

A method, apparatus, system and computer program product are presented for showing a presentation created and running on a mobile device on an external display device wherein the information data content is transferred from the mobile device to the external display device independent of the characteristics, data format and screen resolution of the external display device.

### FIELD OF INVENTION

The present invention relates generally to the presentation of data content in a wireless mobile device and deals more particularly to the viewing of data content originating at a wireless mobile device on the display screen of an external viewing device or as projected onto a display screen by an external viewing device such as a data projector.

The invention also deals with the presentation structure of data content originating at a wireless mobile device wherein the information content displayed at the wireless mobile device may be different than the information content displayed on an external viewing device or projected onto a display screen.

### BACKGROUND OF THE INVENTION

Mobile devices, particularly wireless mobile devices such as cellular telephones have small display screens such that it is not practical or desirable for more than one or two viewers at a time to see the information content displayed on the mobile device screen. In such situations it is desirable to show the information content on an external viewing device however, mobile devices do not have such a capability to connect to an external viewing device.

Unlike personal computers (PC) or similar devices for example, there is no display connector (for example, a VGA connector) in a mobile device to connect the mobile device to an external viewing device, (e.g. to an external display screen or computer screen, data projector or other projection viewing device) for observation of the information content by an audience for example.

Further, even if the mobile device had a display connector of some type, there is no way the mobile device's screen content or applications content could be shown with an external viewing device without first establishing the requisite operating dependencies specific to the external viewing device including a specific protocol for transfer of the data content from the mobile device to the external viewing device either wirelessly or via a hard wire connection. In other words, the mobile device would have dedicated operation with only one specific type of external viewing device and not be operable with another type.

One prior art solution for connecting a mobile device to an external display device requires the use of an intermediary device that communicates with both the mobile device and the display device. In one known prior art method, the mobile device is first connected to a PC using a proprietary protocol to transfer information content from the mobile device to the PC and the PC in turn is connected in a conventional known manner to a suitable external display device. Although such prior art methods are able to show the information content of the mobile device's screen on the external display, the application's content is typically shown with the same resolution as the mobile device's display screen unless the resolution is somehow changed by the PC however, in practice the original resolution as sent from the mobile device is not changed but rather the content is re-sized in a similar manner as done for example in a digital camera. The resolution remains the same but the physical size is bigger and the quality of the image is deteriorated. There are no known methods for an application in a mobile device to send the content of the presentation application to the external display with a different resolution than the resolution used on the mobile device.

Another proposed prior art solution for connecting a mobile device to an external display device contemplates re-design and modification of the mobile device to include a chip-set similar to the chip-sets used in a PC to provide a direct or wired connection to an external display device using the same or a similar interface. Such interfaces used by a PC to connect to an external display are well known and understood by those skilled in the art.

It would be desirable therefore to transfer information data content from a mobile device directly to an external viewing device or data projection device using a generic program that would be suitable for use by mobile devices to enable the mobile device to operate with an external viewing device or data projection device without knowing the specific operating characteristics of the external viewing device or without pre-establishing a transfer protocol specific to the given mobile device and the specific external viewing device.

It is also known to use a mobile device to create or modify the presentation information content such as a slide show for example and it would be desirable to show such presentations on an external viewing device rather than only displaying the presentation information content on the mobile device screen. Such slide shows are typically created and presented using a presentation application running on a PC to create a presentation that consists of separate pages, slides or frames. Slide shows are often employed by speakers to address or make a presentation to an audience on a given subject matter or topic through a sequence of individual slides or frames. Presentation applications such as for example, Microsoft PowerPoint™ are well known and understood by those skilled in the art. These presentation applications generally provide for adding speaker notes to the slide content in a separate viewing portion or area of the slide and the user is able to see both the slide content and speaker notes of the slide. When the presentation is presented to an audience, the “slide show” mode is started and the slide content is shown on the PC screen and if the PC is connected to an external viewing device or display, such as for example a data projector or other projection device, the slide content is projected by the data projector onto a suitable viewing surface for viewing by the audience. A major disadvantage and drawback with such presentation applications is the presenter cannot see the speaker notes of the slide when he or she is presenting the presentation to an audience. The speaker notes can however be seen if the presentation is in the “modification mode” and the “notes view” is selected, however the notes are also shown to the audience along with the presentation. Normally a presenter does not want to show the speaker notes to the audience, and therefore the “notes view” cannot be selected while presenting the slides of the presentation. In the “slide show” mode only the slide content is shown on the PC screen and/or on an external display connected to the PC and the notes are not shown nor are the notes available for viewing by the speaker.

It would be desirable therefore to transfer only the presentation information content of the slide from the mobile device for public or audience viewing on an external viewing device without showing the speaker notes while still showing the speaker notes on the mobile device display screen during the presentation to the audience. Because the speaker's notes are shown on the mobile device display screen, the speaker has mobility and can walk around while making his or her presentation while the audience looks at the presentation information content of the slide without seeing the speaker's notes.

It would also be desirable to show the presentation information content of a slide on the external viewer at a different and preferably higher resolution than the resolution of the mobile device screen.

### SUMMARY OF THE INVENTION

One feature and advantage of the present invention is that a wireless mobile device such as a communicator, for example a Nokia Communicator, can be used to replace a laptop or notebook computer to make presentations, for example, while on a business trip which only lasts a few days. With the invention, a user of a communicator is able to make presentations to large audience with only a presentation application and a data projector or other suitable external viewing device.

The present invention provides a method such that applications can show the information content (e.g. a slide show from presentation application running on the mobile device or the screen capture of the mobile device), with a generic or non-dedicated external viewing device without knowing the specific operating parameters and characteristics of the external display, for example, the type or kind of display used, how the data is transferred (e.g. WLAN, BT, USB cable) between the mobile device and the external viewing device, the data format used, the screen size and the resolution used among others.

The present invention also provides that the mobile device has the capability to connect to an external viewing device without using any other intermediary devices between the mobile device and the external display. It is contemplated that the mobile device connect directly or straight through to a data projector via a WLAN or BT connection and also contemplates other known or future developed connection schemes and systems.

The invention also contemplates that some kind of dongle may be used between the mobile device and the external display or the cable between the mobile device and the external display devices. Dongles are well known and understood by those skilled in the art and are commonly used to prevent copying of software programs.

The invention also contemplates that applications show the presentation information content on the display device with a different resolution than is used on the mobile device. For example, a presentation application could show the presentation information content of slides with a 620×200 resolution on the mobile device's display screen and with a 800×600 resolution on the external viewing device display screen. Preferably, several different resolutions may be selected from.

The invention also contemplates that applications use any now known or future developed data formats, including for example, bitmaps, video stream, command languages, etc.

The invention also contemplates an external view framework, which provides the external viewing device an independent method for the applications running on the mobile device to show the presentation information content data with the external viewing device.

In a further aspect, the present invention provides a presentation structure of data content of a slide in a slide show wherein the presentation information content of the slide is transferred to an external viewing device without showing the speaker notes and wherein the speaker notes associated with the slide are shown on the mobile device display screen only.

The invention further contemplates that the resolution of the external viewing device is different than the resolution of the mobile device display screen.

The invention further contemplates that the resolution of the external viewing device is a higher resolution than the mobile device display screen.

### BRIEF DESCRIPTION OF THE DRAWINGS

Other features, benefits and advantages of the present invention will become readily apparent from the following written description taken in conjunction with the drawings wherein:

FIG. 1 is a schematic representation of a wireless mobile device embodying the external view framework of the present invention to show a presentation using an external viewing device.

FIG. 2 is a functional block diagram of a system context for the external view framework of the present invention.

FIG. 3 is a functional block diagram showing an implementation of the screen export capability embodying the present invention.

FIG. 4 is a flowchart showing the major functional steps for carrying out the method of the invention in a connection between a wireless mobile device and an external data projector for showing the presentation at a desired screen resolution.

FIG. 5 illustrates a slide content that might be shown to the audience in a “slide show” mode, with an external display device for example, with a data projector.

FIG. 6 illustrates the speaker's notes of a slide that might be shown on a computer or mobile device display screen while the audience sees the slide content illustrated in FIG. 5.

### DESCRIPTION OF THE INVENTION

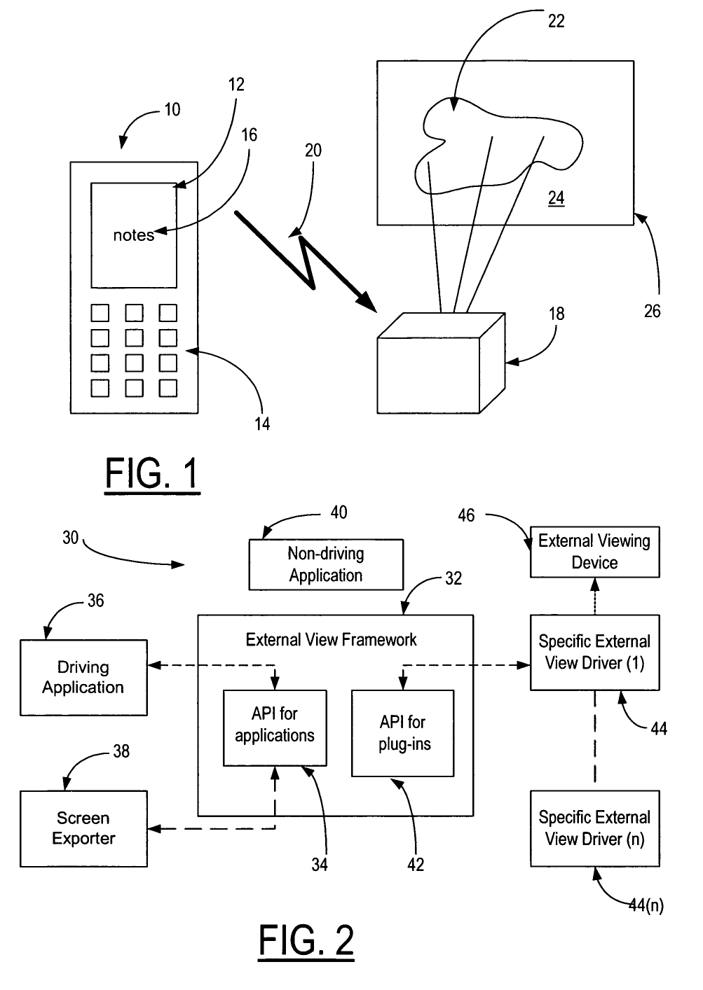

Turning now to the drawings and considering the invention in further detail with particular reference to FIG. 1, a wireless mobile device generally designated 10 embodying the external view framework of the present invention is schematically illustrated therein. The wireless mobile device 10 includes a display screen 12 and a keypad generally designated 14 which functions as a user input to the device 10. The operation and construction of the wireless mobile device 10 is well known and understood by those skilled in the art and is not described in detail herein. A presentation for example a slide show is created on the mobile device 10 using a suitable presentation application such as Microsoft Power Point running on the mobile device. The presentation application is stored in a memory in the mobile device. The presentation information data can be viewed on the display screen 12 along with speaker's notes for example 16 and as explained in further detail below, the user may elect to show only the speaker's notes 16 on the mobile device display screen. The presentation information data is connected directly to an external viewing device, such as a projector generally designated 18 by means of a wireless local area network (WLAN), Bluetooth (BT), USB cable, infrared (IRDA) or any other suitable means generally designated 20 to carry out the intended function. The presentation information data in graphical/text form generally designated 22 is projected by the projector 18 onto the surface 24 of a display screen 26 for viewing. As explained in further detail herein, the presentation information data content is transferred to the projector 18 independent of the characteristics of the projector, independent of the data format of the projector and independent of the screen resolution of the projector.

FIG. 2 is a functional block diagram of a system context generally designated 30 of an external view framework architecture embodying the present invention and is generically described below to identify the major functional components or capabilities to carry out the operational aspects of the invention. The purpose of the framework is to facilitate display of application content onto an external viewing device such as a large screen or data projector. The external view framework 32 provides an application interface program (API) 34 for use by driving application programs represented by the function block generally designated 36 and the screen exporter function block generally designated 38. The API 34 is provided so that applications can send data to an external viewing device in a display independent generic way The driving application is defined as any application that is capable of driving the external view framework and encompasses the presentation application.

The external view framework 32 also provides an application program interface (API) 42 for use by plug-ins which are external view drivers written for specific external viewing devices as represented by the function blocks 44, 44(n) where n is the number of different external view drivers available. The API 42 is provided to create the required driver software between the external view framework 32 and an external viewing device. All the external display specific features of the external viewing device are implemented into a driver plug-in module (software) between external view framework and the external viewing device. The plug-ins are responsible for the last part of delivering the image to the external viewing device 46. For purposes of explanation and understanding of the invention, the driver plug-in module software of the present invention includes but is not limited to for example: how the connection is made from the mobile device to the external display; e.g. a wireless connection by using WLAN, BT or IRDA or, by using a USB cable or some other wired connection; the type of data sent; conversion to generic format data from the application into a format required by the external display, e.g. bitmap images or video stream; the screen resolution of the external display, e.g. 640×480 or 800×600 etc. In other words the driver plug-in manages the transfer of data content from the application running on the mobile device to the external viewer independent of the mobile device and the external viewing device. Accordingly, one or more contexts in accordance with the characteristics of an external viewing device are available for selection and inclusion in the presentation driving program which draws the appropriate driver plug-in using the API for applications 34 and the API for plug-ins 42 in a manner well known to those skilled in the art. The operation and function of driver plug-in modules are well known and understood by those skilled in the art and therefore not discussed further in detail herein.

In summary, the required major functional components to carry out the invention include an external view framework to enable data transfer from presentation applications to an external viewing device; a module without a UI, except for one dialog button to select the appropriate driver for the external viewing device; and one or more appropriate driver plug-ins for a specific external viewing device for example, including but not limited to a WLAN or BT data projector or other desired projection or display device.

The external view framework architecture also contemplates that changes may be required to the given presentation application utilized to add the capability to render document data to an on-screen and off-screen bitmap to be sent to the external viewing device, for example, a suitable data projector. The presentation application menu would be changed if necessary to add new menu items, for example: “Show with external screen” to enable/disable the external viewing device. Another new menu item to be added if necessary would be. for example, “Select external screen” to open a dialog box to select the external viewing device to be used that is, the identifying model of the data projector or other projection device or external display device from a library of such devices. If suitable drivers are not installed in the presentation application or are not available in the operating system, the “Show with external screen” and “Select external screen” features mentioned above are not visible. In other words, if the operating features characteristics of the external viewing device such as a data projector are not available from the mobile device operating system, an existing or newly created presentation application would require that the feature operating characteristics of the data projector be implemented through use of the external view framework API 42 as discussed above.

The screen exporter 38 is also a driving application. The screen export capability is required to be used with the external view framework architecture in order to show the screen content of the mobile device with the external viewing device. The screen exporter 38 is an application that performs a regular screen capture function and then exports the captured image to the external viewing device via the external frame network. In the case of a non-driving application which is defined as an application that does not support driving the external framework as represented by the function block 40, the screen exporter 38 provides a method by which these non-driving applications can have their screen output displayed by the external viewing device without the need to incorporate specific new software support within the application code. It is important to note that there are no software dependencies between the screen exporter 38 and the non-driving applications 40 and accordingly no connection is shown between the non-driving application block 40 and the screen exporter function block 38 in FIG. 2.

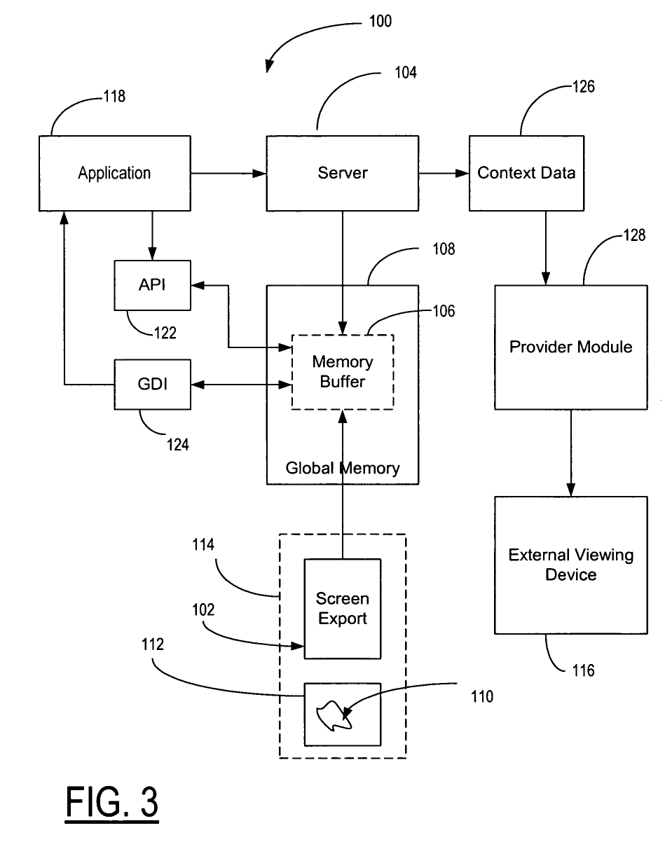

Turning now to FIG. 3, a functional block diagram showing an implementation of the screen export capability embodying the invention is shown therein. It is contemplated that a provider module implementation generally designated 100 would comprise the screen export function and would be available as a separate application or alternately if desired integrated into the mobile device. The application can be any application in which the usage of the external view framework is implemented. A separate application that sends the screen capture data information content to the external viewing device by using the external view framework is provided and downloaded to the mobile device to show the information content of the mobile device's screen on the external viewing device. The screen export UI functionality may also be based on the fax modem capability if present in the mobile device. The application is intended to be operable with now known and future developed mobile devices.

As shown in FIG. 3, the screen export 102 is one client to an external view server 104 and operates by periodic screen grabbing, copying the screen grab data content to a memory buffer 106 in a global memory 108 and then updates the data content information 110 displayed on the screen 112 of the mobile device 114 and shown on the external viewing device 116. Any application 118 can connect to external view server 104 and open a session for external view services. The server 104 makes use of provider modules generally designated 120, which are dynamically loaded libraries implementing an external view plug-in interface. The selected (UI for user selection) provider represents an external viewing device 116 and therefore has characteristics such as for example but not limited to, pixel dimensions and color depth. The external view server 104 creates in accordance with the characteristics a memory buffer 106 in a global memory 108, that is, the content of the memory buffer can be shared among and between processes. A drawing device and context is created to that memory buffer 106. Modern UI's use contexts for drawing and for example, the screen may be one context, a printer may be another context and there can be off-screen memory contexts as contemplated by the invention herein. The application 118 can then draw to that memory context with a common graphics application interface program (API) 122. A Graphics Device Interface (GDI) 124 provides a broad set or range of functions and basically all drawing in the system is carried out using the GDI 124. The GDI 124 is a device that is independent and the same API 122 can be used regardless of the physical device as long as the physical device implements the GDI device interface and the device provides a context. An application then draws to that global memory buffer, and when the drawing is completed, it signals to the external view server 104 and the server passes the context data 126 to the provider module 120. The provider module 120 then sends the context data 126 to the actual external viewing device 116. The process of sending data is controlled and carried out by the provider module 120.

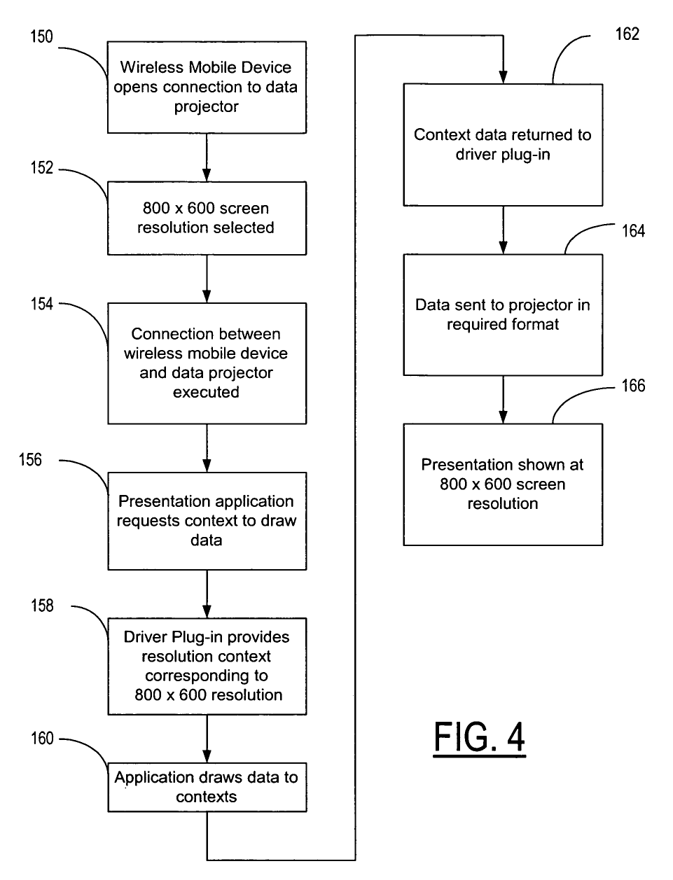

Turning now to FIG. 4, a flowchart is shown therein and is presented to illustrate one possible operation of the invention in which it is desired to show a presentation with a data projector using an 800×600 resolution, wirelessly with a straight connection from the mobile device to the data projector. The method begins with step 150 and the user opens the connection to the data projector using the appropriate function keys on the mobile device running the presentation application. The desired 800×600 resolution is selected in step 152. The external view framework and the driver plug-in module in turn then execute the connection in step 154. The application showing data with the data projector makes a request in step 156 from the external view framework for a context where it (the application) can draw its data. The driver plug-in module in turn gives a correct sized (corresponds to the resolution of the external viewing device) context in step 158. The application then draws its data to the contexts in step 160 and returns the context data to the driver plug-in module in step 162. The driver plug-in module now sends the data in step 164 to the external display in the appropriate requisite format, etc. and the data projector shows the presentation at the 600×800 resolution in step 166, In summary, a generic method is presented to show data with an external viewing device, for example, a data projector. The method provides a way for presentation applications to show data with an external viewing device, which is independent of the external viewing device characteristics, e.g. connection method (wireless, wired, WLAN, BT, IRDA, USB), independent of the data format used to send data to the external viewing device (bitmap, voice/video stream, command set) and independent of the screen resolution of the external viewing device. The method also enables presentation applications to show data information content with a different screen resolution than the screen resolution used in the mobile device.

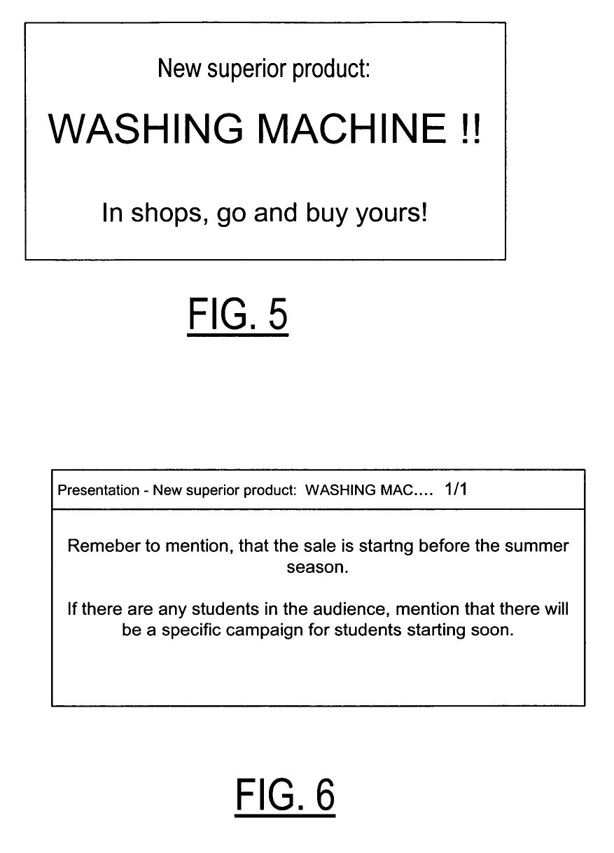

Typically in presentation applications, for example, a slide show presented to an audience, the slide content is shown in so-called “slide show” mode in which only the content of the slide is seen by the audience however the application menus and features of the presentation application to create or modify slides are not visible and not shown. To assist the speaker in making the presentation, speaker notes can be made and are generally written or typed on a paper pad and related to a particular slide and the speaker can see and/or read what to speak about the slide from the written notes. In the present invention, the presentation structure of data content of a presentation application provides that the slide content is shown with external viewing device, e.g. a data projector or other projection device or other suitable display device, and the speaker notes of the slide are shown on a computer screen simultaneously. In other words, the external viewing device and the computer screen display show different information content at the same time. The slide content is shown on an external viewing device as illustrated in FIG. 5 and the speaker notes of the slide are shown on the computer's display screen as illustrated in FIG. 6. This presentation structure is particularly advantageous when the presentation application originates at a mobile device.

The implementation of the presentation structure is such that while the presentation application renders the data information content of the slide to the external viewing device (e.g. data projector) with a high resolution (e.g. 800×600), the presentation application at the same time renders the speaker notes of the slide to the PC or mobile device's screen. When the slide is changed and a new slide is shown with the external viewing device, the speaker notes of the new slide are shown on mobile device's screen. In this way, the speaker can read or refer to the speaker notes shown on the mobile device's screen while the audience can only see the content of the slide.

It is intended that the presentation structure implementation be make to any device with computing features for example a PC, computer or mobile device particularly one which can also be connected to another external viewing device as described herein above. In a wireless presentation from a mobile device of a slide show by an external viewing device such as a data projector, the slide content is sent to the data projector and the speaker notes of the slide are shown on the mobile device display screen. The speaker or presenter can read the speaker notes from mobile device display screen while the audience sees the slide content shown by the data projector. Because the connection to the data projector is wireless, the speaker can walk around the audience and speak and explain the slide content to the audience based on additional comments made in the speaker notes which are not seen by the audience. It is intended that there be a selection option or capability as to whether to show the speaker notes or the slide content on the mobile device display screen.

The invention claimed is:

1. Method comprising the steps of:
creating a presentation on a mobile device using a presentation application running on the mobile device;
transferring the information data content of the presentation from the mobile device to an external display device;
showing the presentation with the external display device;
wherein the step of transferring the information data content further comprises the steps of:
transferring the information data content independent of the characteristics of the external display device;
transferring the information data content independent of the data format of the external display device, and
transferring the information data content independent of the screen resolution of the external display device.

2. The method as defined in claim 1 further comprising the step of showing the presentation at a higher screen resolution than the screen resolution of the mobile device.

3. The method as defined in claim 1 further comprising the step of using an external view framework for transferring the information data content of the presentation to the external display device.

4. The method as defined in claim 3 further comprising the steps of:
creating one or more contexts in accordance with the characteristics of an external display device;
storing the one or more contexts in a memory buffer in a global memory;
drawing by the presentation application from the global memory the appropriate one or more contexts corresponding to the external display device identified;
passing the one or more contexts drawn by the presentation application to a provider module to send the information data content with the specific external display device characteristics to the external display device for showing the presentation on the external display device.

5. The method as defined in claim 1 further including the steps of:
showing only the information data content of the presentation on the external display device, and
simultaneously showing only the speaker notes associated with the presentation on the display screen of the mobile device.

6. The method as defined in claim 1 further including the step of transferring the information data content directly to the external display device via a wireless connection or a hard-wired connection.

7. Mobile device for showing a presentation with an external display device, comprising:
a user interface (UI) for use in creating a presentation with a presentation application running on the mobile device, said UI having at least one dialog button for selecting one or more appropriate driver plug-ins corresponding to the external display device showing the presentation from the mobile device for transfer to a provider module along with the data information content of the presentation for sending to the external display device to show the presentation.

8. System, comprising:
a mobile device;
an external display device;
a presentation application running on the mobile device for creating a presentation;
a global memory for storing one or more contexts corresponding to the characteristics of the external display device;
a user interface (UI) on said mobile device for use in selecting one or more appropriate driver plug-ins corresponding to the desired external display device to be used in showing the presentation;
a provider module for receiving the one or more appropriate driver plug-ins selected and the one or more contexts along with the data information content of the presentation for transfer to the external display device to show the presentation.

9. The system as defined in claim 8 wherein the external display device is a data projector.

10. The system as defined in claim 8 wherein the presentation is shown by the external display device with a higher screen resolution than the resolution of the mobile device screen.

11. The system as defined in claim 8 further comprising the mobile device having a display screen and the presentation being a slide show whereby only the information data content of a slide in the presentation is transferred for showing with the external display device and speaker notes associated with the slide are shown on the mobile device display screen.

12. A computer program product, comprising a storage medium having a software application for showing using an external display device a presentation created on a mobile device including program code for transferring the information data content of the presentation from the mobile device to the external display device, wherein the information data content is transferred independent of the data format of the external display device, and wherein the information data content is transferred independent of the data format of the external display device, and wherein the information data content is transferred independent of the screen resolution of the external display device.

13. Computer program carried on a storage medium and executable by a processor in a mobile device for showing using an external display device a presentation created on the mobile device using a presentation application running on the mobile device and for transferring the information data content of the presentation from the mobile device to the external display device independent of the characteristics, data format and screen resolution of the external display device.
